(19) United States
(12) Patent Application Publication
(10) Pub. No.: US 2018/0257302 A1
(43) Pub. Date: Sep. 13, 2018

(54) A MULTI-MODAL PRINTING SYSTEM AND METHOD OF OPERATING THE SAME

(71) Applicant: AGENCY FOR SCIENCE, TECHNOLOGY AND RESEARCH, Singapore (SG)

(72) Inventors: Ruihua Eugene KHENG, Singapore (SG); Saeed MALEK-SAEEDI, Singapore (SG); Jun WEI, Singapore (SG)

(21) Appl. No.: 15/748,174

(22) PCT Filed: Jul. 26, 2016
(86) PCT No.: PCT/SG2016/050351

§ 371 Date: Jan. 26, 2018

(30) Foreign Application Priority Data
Jul. 27, 2015 (SG) 10201505849T

(51) Int. Cl. B29C 64/386; B29C 64/135; B29C 64/205

(52) U.S. Cl. CPC B29C 64/386; B33Y 30/00; B29C 64/205; B29C 64/135

(57) ABSTRACT

A multi-modal printing system for printing a 3-dimensional object and method of operating the system are provided. The system comprises multiple layers of photoresin, in a stereolithography apparatus comprising a high speed resin applicator for applying the layers of photoresin, wherein the multi-modal printing system comprises a control mechanism configured to selectively control the high speed resin applicator to perform a discreet operation, a continuous operation, and a self-reset operation.

### FIELD OF INVENTION

The present invention generally relates to a multi-modal printing system and method of operating the same.

### BACKGROUND

Stereolithography is an early method of three-dimensional printing by adding one layer of material on top of another. The first additive manufacturing process involves focusing and moving an ultraviolet (UV) laser, controlled by a computer aided design software (CAD), on the surface of a vat of photopolymer resin. As photopolymers are photosensitive to UV light, undergoing a polymerization reaction and solidifying to form a single microns-thick layer of the desired three-dimensional object. The curing process is repeated, alternating with a recoating process to reposition and coat the prior cured parts in uncured resin, for each layer until the entire object is completed. Today, most modern vat-type stereolithography apparatus typically have a recoater which holds resin inside the recoater above the liquid surface, and sucked from the vat by negative pressure. This reservoir of negative pressure resin coats the dry parts of the exposed object. Traditional stereolithography apparatus without recoaters dip the part further into the liquid than the layer thickness to suck additional resin above the part, the part is then raised to the appropriate depth to set the layer thickness. A pause is now necessary for the resin to level or a levelling device is activated. All stereolithography printers require certain manual intervention to reset the print surface and start the next print job.

There are speed limitations when using a negative pressure recoater because there is an additional step required in the process to fill the recoater with photoresin from the vat. Traditional stereolithography machines employing a static vat and a leveller require the z-stage to move much further than the layer thickness to overcome surface tension to pull resin on top of the cured part. These inefficiencies in the layer resetting mechanisms add unproductive time (time not spent curing) to the operation of stereolithography machines. In addition, as convenience has not been a priority of the 3D printing industry or manufacturers, human intervention is required to remove printed parts, clean the print surface and start any subsequent print jobs. Efficient and continuous operation of the printer cannot be achieved if the steps of, removing the printed part, cleaning the print surface and restarting the printer, was forgotten or delayed by its human operator. This loss of machine time is evident if a stereolithography machine is not operated in a shift environment and is inefficient to any company operating such a machine. The technologies described in embodiments of the present invention seek to improve the general speed and convenience of operation of 3D Printers.

Accordingly, a need exists to provide a stereolithography machine that seeks to address some of the above problems. Furthermore, other desirable features and characteristics will become apparent from the subsequent detailed description and the appended claims, taken in conjunction with the accompanying drawings and this background of the disclosure.

### SUMMARY

According to a first aspect of the present invention, there is provided a multi-modal printing system for printing a 3-dimensional object, comprising multiple layers of photoresin, in a stereolithography apparatus comprising a high speed resin applicator for applying the layers of photoresin, wherein the multi-modal printing system comprises a control mechanism configured to selectively control the high speed resin applicator to perform a discreet operation, a continuous operation, and a self-reset operation.

In an embodiment, the high speed resin applicator simultaneously sets and levels a layer of photoresin during a layer reset operation.

In an embodiment, the stereolithography apparatus may further comprise an expandable vat having a volume defined by vat sidewalls and a base, and the control mechanism is configured to expand a volume of the vat.

In an embodiment, the control mechanism may be configured to control the high speed resin applicator to travel at a fixed height relative to the top of the side walls of the vat, and to apply one of the multiple layers of photoresin while simultaneously levelling the layer of photoresin, the layer of photoresin being applied on a curing plane defined within the vat sidewalls.

In an embodiment, the expandable liquid vat may be liquid-tight and the control mechanism may be configured to displace the vat side walls upward relative to the base by a distance equal to a thickness of the layer of photoresin, thereby expanding the volume of the vat, after the layer of photoresin has been applied by the applicator.

In an embodiment, the expandable liquid vat may be liquid-tight and the control mechanism may be configured to displace the base of the vat downward relative to the vat sidewalls by a distance equal to a thickness of the layer of photoresin, thereby expanding the volume of the vat, after the layer of photoresin has been applied by the applicator.

In an embodiment, the expandable liquid vat may be liquid-tight and the control mechanism may be configured to displace the vat sidewalls and base relative to each other, by upward movement of the vat sidewalls relative to the base and downward movement of the base of the vat relative to the vat sidewalls, by a distance equal to a thickness of the layer of photoresin, thereby expanding the volume of the vat, after the layer of photoresin has been applied by the applicator.

In an embodiment, the side walls of the vat may be raised, by said distance, when the high speed resin applicator reaches an end of the vat in a two-way operation and the high speed resin applicator applies resin while travelling in both directions.

In an embodiment, the side walls of the vat may be raised, by said distance, when the high speed resin applicator reaches a specific end of the vat in one direction of a one-way operation and the applicator applies resin while travelling in the one direction.

In an embodiment, the stereolithography apparatus may further comprise a tracking device controlled by the control mechanism to track movement of the high speed resin applicator during the continuous operation.

In an embodiment, the tracking device may be configured to continuously measure the high speed resin applicator position.

In an embodiment, the stereolithography apparatus may further comprise a curing device that is above the vat.

In an embodiment, the stereolithography apparatus may further comprise a curing device that is above the vat and the curing device is configured to move upwards with respect to the base of the vat during every layer reset to maintain the curing device at a fixed height relative to the curing plane.

In an embodiment, the stereolithography apparatus may further comprise a special-shaped print tray for utilizing during the self-reset operation.

In an embodiment, the special-shaped print tray may comprise a recessed portion on the upper surface of the print tray to allow a photoresin to cure in a partially attached base layer; and a cutter, wherein the recessed portion is coupled to a hydraulic pump which is configured to pressurize the resin under the base layer to detach and bulge out the majority of the base layer in preparation for cutting and wherein the cutter detaches the outer edge of the finished product from the print tray and deposits the finished product in a collection bin.

In an embodiment, the special-shaped print tray may comprise a low stick material selected from the group of materials comprising acrylonitrile butadiene styrene (ABS), Teflon®, Teflon® derivatives, Polyethylene, Polystyrene, Polypropylene, Nylon, Polyamide, Polymethyl methacrylate (PMMA), Polyurethane, polyvinyl chloride (PVC), aluminum, aluminum alloys, magnesium, magnesium alloys, titanium, titanium alloys, steel, Inconel, cast iron, copper based alloys, bronze, brass, glass, quartz, alumina, and zirconia.

According to a second aspect of the present invention, there is provided a method for printing a 3-dimensional object in a stereolithography apparatus having a control mechanism and a high speed resin applicator for applying a layer of photoresin to a part being printed by the stereolithography apparatus, the control mechanism configured to selectively control operation of the apparatus, the method comprising controlling the high speed resin applicator, using the control mechanism, to perform a 3-dimensional printing operation comprising at least one of a discreet operation; a continuous operation and a self-reset operation.

In an embodiment, the stereolithography apparatus may comprise an expandable vat having vat sidewalls and a base, the vat containing liquid and the part being printed by the stereolithography apparatus, and wherein performing the discreet operation comprises the steps of moving the vat sidewalls upwards by a thickness of the layer of photoresin; applying a layer of photoresin, using a high speed resin applicator, on top of the liquid and part simultaneously while levelling the layer of photoresin; and pausing application of the layer of photoresin and, while addition of the layer of photoresin is paused, curing a single cross sectional layer of the part using a curing device maintained at a fixed height relative to the layer of photoresin.

In an embodiment, the stereolithography apparatus may comprise an expandable vat having vat sidewalls and a base, the vat containing liquid and the part being printed by the stereolithography apparatus, and wherein performing the continuous operation comprises the steps of moving the vat sidewalls upwards by a thickness of the layer of photoresin; applying a layer of photoresin, using a high speed resin applicator, on top of the liquid and part simultaneously while levelling the layer of photoresin; continuously applying resin and simultaneously curing the part using a curing device maintained at a fixed height relative to the cure plane; and measuring a position of the applicator continuously to allow projection of different layer images before and after application of the layer of photoresin, thus curing two different cross sectional layers simultaneously without having to pause the applicator during the curing process.

In an embodiment, the stereolithography apparatus may comprise a print tray within the vat and operating in the self-reset operation comprises the steps of upon application of a final layer of photoresin for completing 3-dimensional printing of the part, pressurizing the final layer of photoresin under a base layer to detach the majority of the base layer, wherein the base layer is a layer of photoresin applied first during 3-dimensional printing of the part; separating the part from the print tray by using a cutter to detach an outer edge of the part from the tray; and depositing the part into a collection bin.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a side cross-sectional view of a stereolithography apparatus in a discreet operation according to a first embodiment.

FIG. 2 shows a side cross-sectional view of a stereolithography apparatus in a continuous operation according to a second embodiment.

FIG. 3 shows a side cross-sectional view of a tray assembly of the stereolithography apparatus of FIG. 1 and FIG. 2.

FIG. 4 shows a flowchart illustrating a method for operating a stereolithography apparatus in a discreet operation according to an example embodiment.

FIG. 5 shows a flowchart illustrating a method for operating a stereolithography apparatus in a continuous operation according to an example embodiment.

FIG. 6 shows a flowchart illustrating a method for operating a stereolithography apparatus in a self-reset operation according to an example embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. Herein, a multi-modal printing system and method of operating the same are presented in accordance with present embodiments having the advantages of faster print speeds, improved durability, enhanced efficiency and greater performance.

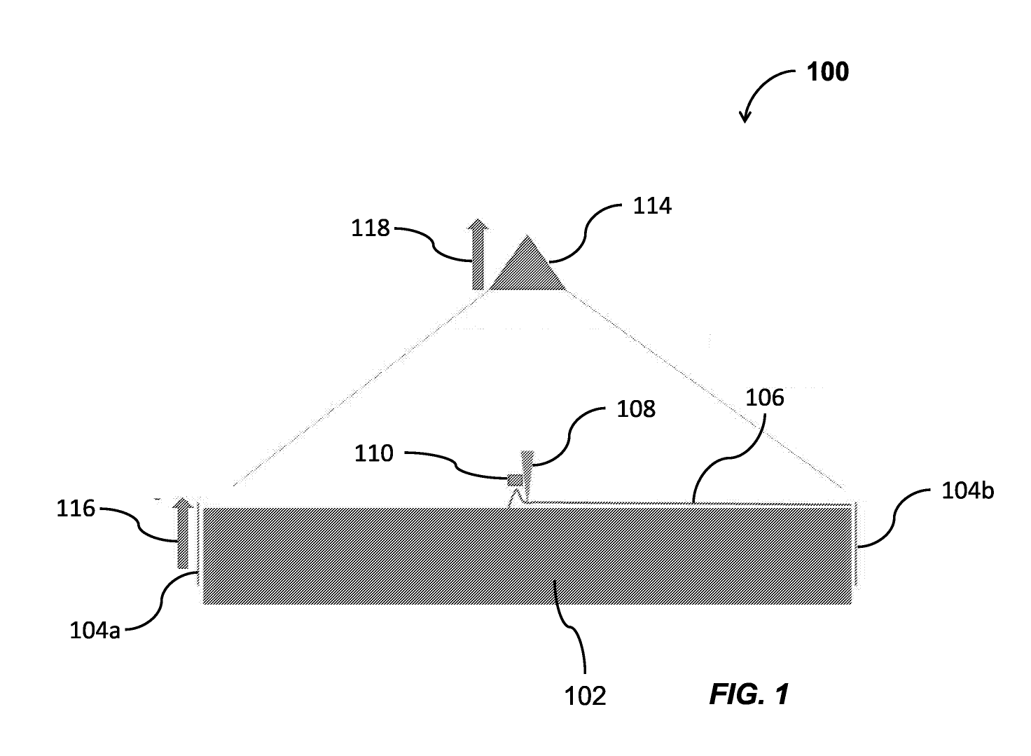

FIG. 1 shows a side cross-sectional view of a stereolithography apparatus in a discreet operation according to a first embodiment the stereolithography apparatus 100 comprises an expandable container 102, such as a liquid-tight vat, having a volume defined by side walls 104a 104b, a base (not shown) and a control mechanism (not shown), wherein the control mechanism is configured to expand a volume of the vat 102. The apparatus 100 further comprises a high speed resin applicator 110 for applying layers of photoresin and a leveler 108. The control mechanism is also configured to control the high speed resin applicator 110 to perform a discreet operation, a continuous operation and a self-reset operation. The apparatus 100 also comprises a curing device 114, for example a digital light processing (DLP) projector or a laser writing system that is positioned above the vat 102.

As shown in FIG. 1, the vat 102 contains a cured part and uncured photoresin at the start of the layer reset operation. In a discreet operation, the high speed resin applicator 110 applies a layer of photoresin 106 on top of the uncured photoresin from an end of the vat 104b to the opposite end of the vat 104a. The layer of photoresin 106 is applied on a curing plane defined within the side walls 104a 104b of the vat 102. The leveler 108 levels the layer of photoresin 106 simultaneously after application by the high speed resin applicator 110 using a pressure difference between the uncured photoresin in the vat 102 and the high speed resin applicator 110. The control mechanism is configured to control the high speed resin applicator 110 to travel at a fixed height relative to the top of the side walls 104a 104b of the vat 102 and to apply one of the multiple layers of photoresin while simultaneously levelling the layer of photoresin 106.

In one embodiment in FIG. 1, after the layer of photoresin 106 is applied by the high speed resin applicator 110, the control mechanism displaces the vat sidewalls 104a 104b upwards 116 relative to the base of the vat 102 by a distance equal to a thickness of the layer of photoresin 106, thereby expanding the volume of the vat 102. Alternatively, the control mechanism may displace the base of the vat 102 downwards relative to the vat sidewalls 104a 104b by a distance equal to a thickness of the layer of photoresin 106, thereby expanding the volume of the vat 102. In yet another alternate embodiment, after the layer of photoresin 106 is applied by the high speed resin applicator 110, the control mechanism may also displace the vat sidewalls 104a 104b and base of the vat relative to each other by upward movement 116 of the vat sidewalls 104a 104b relative to the vat base and downward movement of the vat base relative to the vat sidewalls 104a 104b, by a distance equal to a thickness of the layer of photoresin 106.

In the discreet one-way operation as shown in FIG. 1, the high speed resin applicator 110 returns to its original starting position after the layer of photoresin 106 is applied across the surface of the vat 102 in one direction in a layer reset operation. The vat sidewalls 104a 104b are subsequently raised by the distance equal to a thickness of the layer of the photoresin 106 applied when the high speed resin applicator 110 reaches a specific end of the vat after applying the layer of photoresin 106 in the one direction.

Thereafter, the curing device 114 above the vat 102 selectively cures the required areas of the applied layer of photoresin 106 after the layer reset operation whereby the high speed resin applicator 110 returns to its original starting position. The curing device 114 is further configured to move upwards 118 with respect to the base of the vat during every layer reset operation to maintain the curing device 114 at a fixed height relative to the curing plane. After curing of the layer of photoresin 106, the high speed resin applicator 110 applies the next layer of photoresin and the process is repeated until the desired three-dimensional object is printed.

By providing movable vat sidewalls 104a 104b which expands the volume of the vat 102 and adding a layer of photoresin 106 on the existing cured part and liquid resin while simultaneously levelling, it is possible to reduce the time spent on the layer resetting process over current stereolithography machines. The above described embodiment may also increase printing speeds of up to 300 millimetres per hour over current printers which currently have a maximum printing speed of 15 millimetres per hour.

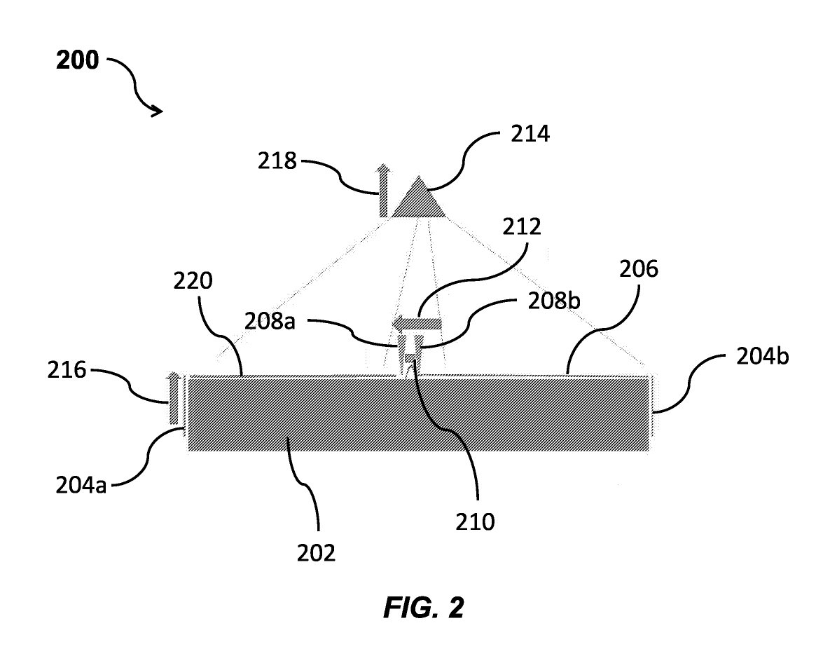

FIG. 2 shows a side cross-sectional view of a stereolithography apparatus in a continuous operation according to a second embodiment. In this Figure, the apparatus 200 comprises a liquid-tight vat 202 having a volume defined by side walls 204a 204b, a base (not shown) and a control mechanism (not shown), wherein the control mechanism is configured to expand a volume of the vat 202. The apparatus 200 further comprises a high speed resin applicator 210 for applying layers of photoresin and two levelers 208a 208b. The presence of the two levelers 208a 208b allows the apparatus 200 to perform a continuous operation without having to carry out a layer resetting operation. The apparatus 200 also comprises a curing device 214 that is positioned above the vat 202.

Similar to FIG. 1, the vat 202 of FIG. 2 contains a cured part and uncured photoresin at the start of the operation. In the continuous operation, the high speed resin applicator 210 applies a layer of photoresin 206 on a curing plane on top of the uncured photoresin from an end of the vat 204b across to the opposite end of the vat 204a, the curing plane defined within the vat sidewalls 204a 204b. The leveler 208b levels the layer of photoresin 206 simultaneously after application by the high speed resin applicator 210. The control mechanism is configured to control the high speed resin applicator 210 to travel at a fixed height relative to the top of the vat side walls 204a 204b and to apply one of the multiple layers of photoresin while simultaneously levelling the layer of photoresin 206.

When the high speed resin applicator 210 reaches the opposite end of the vat, the sidewalls 204a 204b are raised a distance equal to a thickness of the layer of the photoresin 206. The high speed resin applicator 210 applies the next layer of photoresin in the opposite direction and the leveler 208a simultaneously levels the layer of photoresin after application. Thus, the high speed resin applicator 210 applies photoresin on the vat while travelling in both directions and the sidewalls 204a and 204b are similarly raised in this two-way operation. The apparatus 200 may also comprise a tracking device (not shown) controlled by the control mechanism to track movement of the high speed resin applicator 210 during the continuous operation. The tracking device is further configured to continuously measure the position of the high speed resin applicator 210. The position of the high speed resin applicator 210 is relayed to a computer or software and the curing device 214 continuously adjusts the image projected onto the cure surfaces. This allows different layers to be cured in front and behind the high speed resin applicator 210. For example, as shown in FIG. 2, the curing device 214 cures the photoresin layer 206 as well as the previous layer 220 as the applicator moves in the direction 212.

The two way operation of the apparatus 200 in FIG. 2 allows for continuous deposition of the photoresin and curing. A layer reset operation is not required and thus the curing device 214 does not have to pause for the high speed resin applicator 210 to reset into its original position. The applicator 210 also does not stop for the curing device 214 to finish the curing phase as curing and deposition are carried out simultaneously.

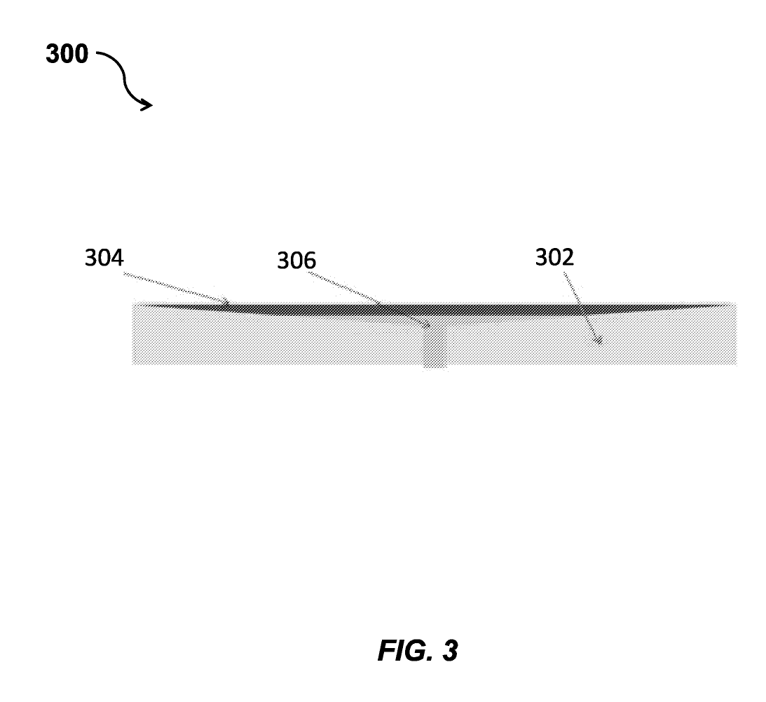

FIG. 3 shows a side cross-sectional view of a tray assembly 300 of the stereolithography apparatus of FIG. 1 and FIG. 2. The tray assembly 300 may comprise a single or multiple special-shaped surfaces 302 for holding the printed object and may be utilized during the self-reset operation. The surface apparatus 100 200 is configured to cure to a depth of “X” microns and as the first layer is exposed on the print surface, a partially attached base layer 304 is cured to a depth of X microns, wherein “X microns” is any depth, for example 50-100 microns. The print tray 302 comprises a recessed portion on the upper surface of the print tray 302, that is 1.1× to 1.5× deep, to allow the photoresin to cure in the partially attached base layer 304 and a cutter (not shown). Multiple entry shaped points may be joined to form a single print tray. The recessed portion is further coupled to a hydraulic pump (not shown). After the object has been printed and cured by the apparatus 100 and 200, the hydraulic pump is configured to pressurize the resin under the base layer 304 to detach and bulge out the majority of the base layer 304 in preparation for cutting. This is achieved by introducing an appropriate amount of resin 306 into a cavity of the tray 302 to detach most of the base layer 304 and the printed object from the tray 302, leaving only with a thin margin of the outer edge of the finished product attached to the outside edge of the tray 302. The print tray 302 may further comprise a low stick material selected from the group of materials comprising acrylonitrile butadiene styrene (ABS), Teflon®, Teflon® derivatives, Polyethylene, Polystyrene, Polypropylene, Nylon, Polyamide, Polymethyl methacrylate (PMMA), Polyurethane, polyvinyl chloride (PVC), aluminum, aluminum alloys, magnesium, magnesium alloys, titanium, titanium alloys, steel, Inconel, cast iron, copper based alloys, bronze, brass, glass, quartz, alumina, and zirconia. This allows the finished object to be detached from the tray 302 with ease. The tray 302 may comprise a cutter (not shown) which detaches the outer edge of the finished product from the print tray 302 and deposits the finished product in a collection bin.

The autonomous method for separating the printed object from the tray 302 as described above allows for continuous printing of multiple objects with no human intervention required. A print queue can be established and the apparatus 100 200 can be used without the need for manual intervention to reset the print surface. Therefore, print time may be faster and greater efficiency may be achieved.

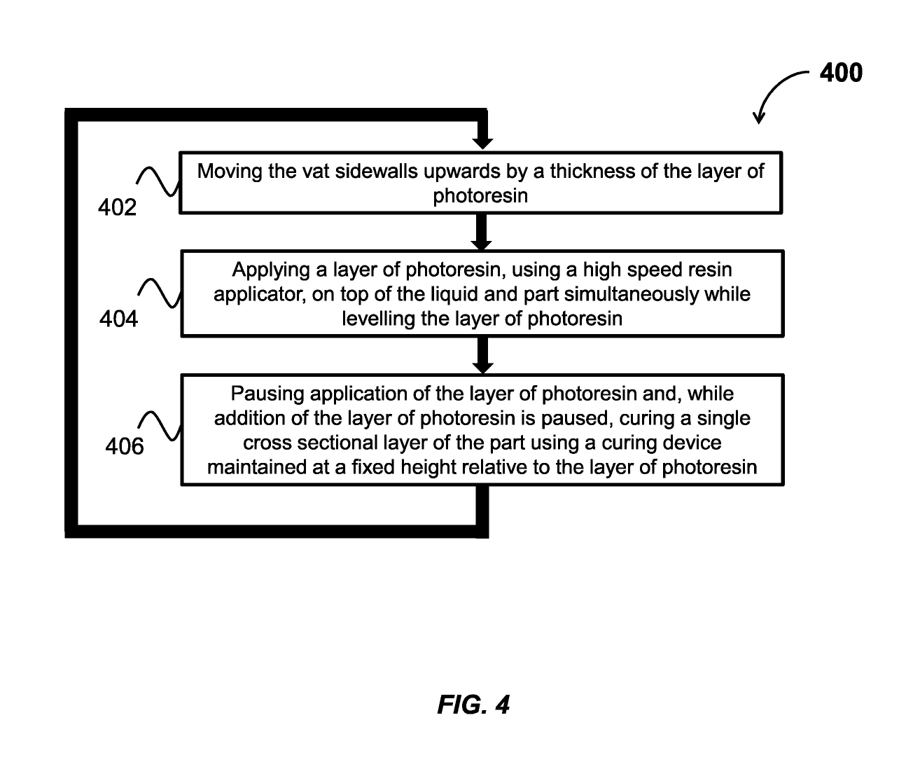

FIG. 4 shows a flowchart illustrating a method 400 for operating a stereolithography apparatus in a discreet operation according to an example embodiment. The method 400 comprises, at step 402, moving the vat sidewalls upwards by a thickness of the layer of photoresin, and at step 404, applying a layer of photoresin, using a high speed resin applicator, on top of the liquid and part simultaneously while levelling the layer of photoresin. At step 406, the method includes pausing application of the layer of photoresin and, while addition of the layer of photoresin is paused, curing a single cross sectional layer of the part using a curing device maintained at a fixed height relative to the layer of photoresin. These steps are repeated as many times as necessary to produce the entire part one layer at a time.

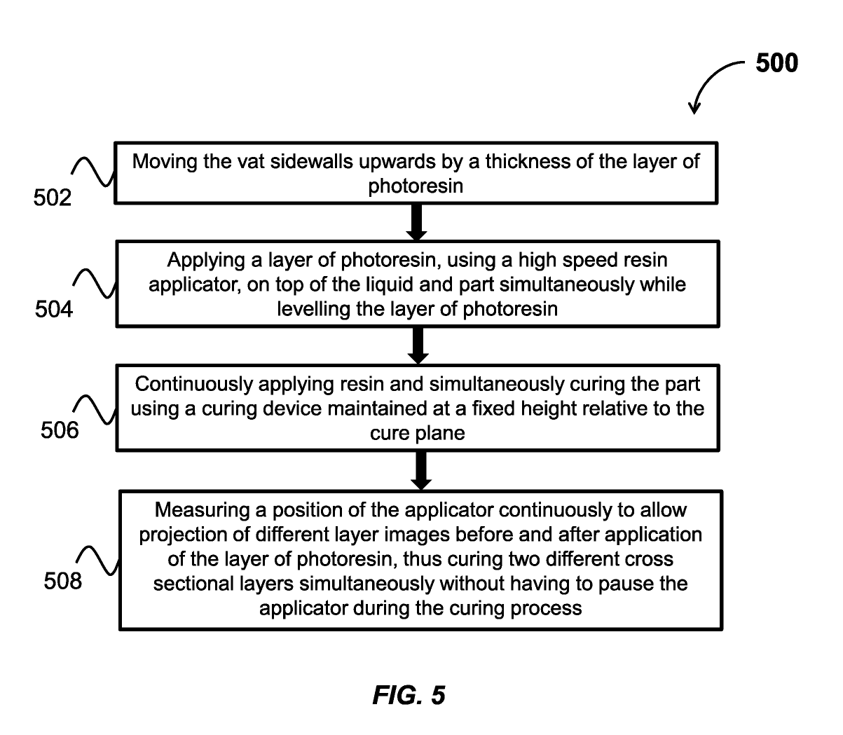

FIG. 5 shows a flowchart illustrating a method 500 for operating a stereolithography apparatus in a continuous operation according to an example embodiment. The method 500 comprises, at step 502, moving the vat sidewalls upwards by a thickness of the layer of photoresin, and at step 504, applying a layer of photoresin, using a high speed resin applicator, on top of the liquid and part simultaneously while levelling the layer of photoresin. At step 506, the method comprises continuously applying resin and simultaneously curing the part using a curing device maintained at a fixed height relative to the cure plane. At step 508, the method includes measuring a position of the applicator continuously to allow projection of different layer images before and after application of the layer of photoresin. This method allows curing of the two different cross sectional layers to occur simultaneously without the requirement for a pause in the layer reset operation. These steps are repeated as many times as necessary to produce the entire part one layer at a time.

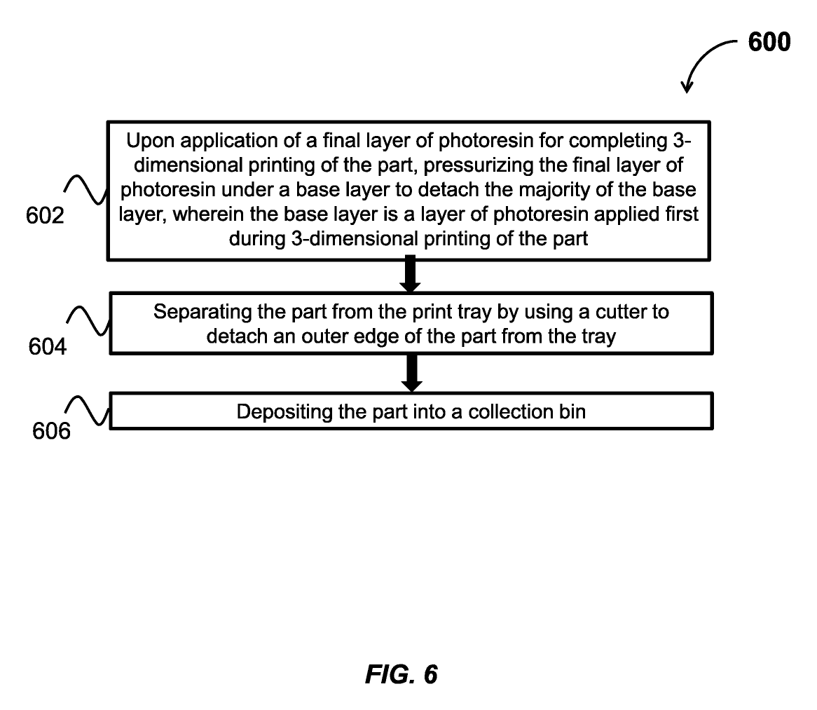

FIG. 6 shows a flowchart illustrating a method 600 for operating a stereolithography apparatus in a self-reset operation according to an example embodiment. The method 600 comprises, at step 602, upon application of a final layer of photoresin for completing 3-dimensional printing of the part, pressurizing the final layer of photoresin under a base layer to detach the majority of the base layer, wherein the base layer is a layer of photoresin applied first during 3-dimensional printing of the part. At step 604, the method includes separating the part from the print tray by using a cutter to detach an outer edge of the part from the tray and at step 606, the method includes depositing the part into a collection bin. Subsequent print jobs can now be started autonomously after this step.

Thus it can be seen that the apparatus in accordance with the present embodiments have the advantages of improving the print speed for a three-dimensional object, reducing the print time of an object, improved efficiency and requires little manual intervention. While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1-20. (canceled)

21. A multi-modal printing system for printing a 3-dimensional object, comprising multiple layers of photoresin, in a stereolithography apparatus comprising a resin applicator for applying the layers of photoresin and an expandable vat having a volume defined by vat sidewalls and a base, wherein the multi-modal printing system comprises a control mechanism configured to:
(i) displace the vat side walls relative to the base by a distance equal to a thickness of a layer of photoresin, thereby expanding the volume of the vat, after the layer of photoresin has been applied by the resin applicator; and
(ii) selectively control the resin applicator to perform a one-way operation, a two-way operation, and an autonomous reset operation.

22. The multi-modal printing system of claim 21, wherein the resin applicator simultaneously sets and levels the layer of photoresin during a layer reset operation.

23. The multi-modal printing system of claim 21, wherein the control mechanism is configured to control the resin applicator to travel at a fixed height relative to the top of the side walls of the vat, and to apply one of the multiple layers of photoresin while simultaneously levelling the layer of photoresin, the layer of photoresin being applied on a curing plane defined within the vat sidewalls.

24. The multi-modal printing system of claim 23, wherein the expandable liquid vat is liquid-tight and the control mechanism is configured to displace the vat side walls upward relative to the base by a distance equal to a thickness of the layer of photoresin, thereby expanding the volume of the vat, after the layer of photoresin has been applied by the applicator.

25. The multi-modal printing system of claim 23, wherein the expandable liquid vat is liquid-tight and the control mechanism is configured to displace the base of the vat downward relative to the vat sidewalls by a distance equal to a thickness of the layer of photoresin, thereby expanding the volume of the vat, after the layer of photoresin has been applied by the applicator.

26. The multi-modal printing system of claim 23, wherein the expandable liquid vat is liquid-tight and the control mechanism is configured to displace the vat sidewalls and base relative to each other, by upward movement of the vat sidewalls relative to the base and downward movement of the base of the vat relative to the vat sidewalls, by a distance equal to a thickness of the layer of photoresin, thereby expanding the volume of the vat, after the layer of photoresin has been applied by the applicator.

27. The multi-modal printing system of claim 24, wherein the side walls of the vat are raised, by said distance, when the resin applicator reaches an end of the vat in the two-way operation and the resin applicator applies resin while travelling in both directions.

28. The multi-modal printing system of claim 24, wherein the side walls of the vat are raised, by said distance, when the resin applicator reaches a specific end of the vat in one direction of the one-way operation and the applicator applies resin while travelling in the one direction.

29. The multi-modal printing system of claim 22, wherein the stereolithography apparatus further comprises a tracking device controlled by the control mechanism to track movement of the resin applicator during the two-way operation.

30. The multi-modal printing system of claim 29, wherein the tracking device is configured to continuously measure the resin applicator position.

31. The multi-modal printing system of claim 21, wherein the stereolithography apparatus further comprises a curing device that is above the vat.

32. The multi-modal printing system of claim 23, wherein the stereolithography apparatus further comprises a curing device that is above the vat and the curing device is configured to move upwards with respect to the base of the vat during every layer reset to maintain the curing device at a fixed height relative to the curing plane.

33. The stereolithography apparatus of claim 21, further comprising a print tray, wherein the print tray comprises:
a recessed portion on the upper surface of the print tray to allow a photoresin to cure in a partially attached base layer; and
a cutter,
wherein the recessed portion is coupled to a hydraulic pump which is configured to pressurize the resin under the base layer to detach and bulge out the majority of the base layer in preparation for cutting and wherein the cutter detaches the outer edge of the finished product from the print tray and deposits the finished product in a collection bin.

34. The stereolithography apparatus of claim 33, wherein the print tray comprises a low stick material selected from the group of materials comprising acrylonitrile butadiene styrene (ABS), Teflon®, Teflon® derivatives, Polyethylene, Polystyrene, Polypropylene, Nylon, Polyamide, Polymethyl methacrylate (PMMA), Polyurethane, polyvinyl chloride (PVC), aluminum, aluminum alloys, magnesium, magnesium alloys, titanium, titanium alloys, steel, Inconel, cast iron, copper based alloys, bronze, brass, glass, quartz, alumina, and zirconia.

35. A method for printing a 3-dimensional object in a stereolithography apparatus having a control mechanism, an expandable vat having a volume defined by vat sidewalls and a base and a resin applicator for applying a layer of photoresin to a part being printed by the stereolithography apparatus, the control mechanism configured to selectively control operation of the apparatus, the method comprising:
displacing, using the control mechanism, the vat side walls relative to the base by a distance equal to a thickness of the layer of photoresin, thereby expanding the volume of the vat, after the layer of photoresin has been applied by the resin applicator; and
controlling the resin applicator, using the control mechanism, to perform a 3-dimensional printing operation comprising at least one of:
a one-way operation;
a two-way operation; and
an autonomous reset operation.

36. The method of claim 35, wherein the vat contains liquid and the part being printed by the stereolithography apparatus, and wherein the control mechanism is configured to perform the one-way operation comprising:
moving the vat sidewalls upwards by the thickness of the layer of photoresin;
applying the layer of photoresin, using the resin applicator, on top of the liquid and the part simultaneously while levelling the layer of photoresin; and
pausing application of the layer of photoresin and, while addition of the layer of photoresin is paused, curing a single cross sectional layer of the part using a curing device maintained at a fixed height relative to the layer of photoresin.

37. The method of claim 35, wherein the vat contains liquid and the part being printed by the stereolithography apparatus, and wherein the control mechanism is configured to perform the two-way operation comprising:
moving the vat sidewalls upwards by the thickness of the layer of photoresin;
applying the layer of photoresin, using the resin applicator, on top of the liquid and part simultaneously while levelling the layer of photoresin;
continuously applying resin and simultaneously curing the part using a curing device maintained at a fixed height relative to the cure plane; and
measuring a position of the applicator continuously to allow projection of different layer images before and after application of the layer of photoresin, thus curing two different cross sectional layers simultaneously without having to pause the applicator during the curing process.

38. The method of claim 35, wherein the stereolithography apparatus comprises a print tray within the vat, wherein the control mechanism is configured to perform the autonomous reset operation comprising:
upon application of a final layer of photoresin for completing 3-dimensional printing of the part, pressurizing the final layer of photoresin under a base layer to detach the majority of the base layer, wherein the base layer is a layer of photoresin applied first during 3-dimensional printing of the part;
separating the part from the print tray by using a cutter to detach an outer edge of the part from the tray; and
depositing the part into a collection bin.
